(19) United States
(12) Patent Application Publication
(10) Pub. No.: US 2019/0222668 A1
(43) Pub. Date: Jul. 18, 2019

(54) SYSTEM AND METHOD FOR CORRELATION-AWARE CACHE-AIDED CODED MULTICAST (CA-CACM)

(71) Applicant: NOKIA OF AMERICA CORPORATION, Murray Hill, NJ (US)

(72) Inventors: Antonia Maria TULINO, Murray Hill, NJ (US); Jaime LLORCA, Murray Hill, NJ (US); Atul DIVEKAR, Murray Hill, NJ (US)

(73) Assignee: NOKIA OF AMERICA CORPORATION, Murray Hill, NJ (US)

(21) Appl. No.: 16/329,450

(22) PCT Filed: Sep. 6, 2017
(86) PCT No.: PCT/US17/50256

§ 371 Date: Feb. 28, 2019

Related U.S. Application Data
(60) Provisional application No. 62/384,446, filed on Sep. 7, 2016.

(51) Int. Cl. H04L 29/08; H04L 12/26

(52) U.S. Cl. CPC H04L 67/2852; H04L 67/32; H04L 43/045; H04L 67/06

(57) ABSTRACT

Requests are received from destination devices for files of a plurality of data files, each of the requested files including at least one file-packet. A conflict graph is built using popularity information and a joint probability distribution of the plurality of date files. The conflict graph is colored. A coded multicast is computed using the colored conflict graph. A corresponding unicast refinement is computed using the colored conflict graph and the joint probability distribution of the plurality of data files. The coded multicast and the corresponding unicast is concatenated. The requested files are transmitted to respective destination devices of the plurality of destination devices.

### PRIORITY STATEMENT

This application claims priority to provisional U.S. application No. 62/384,446 filed on Sep. 7, 2016, the contents of which is hereby incorporated by reference in its entirety.

### BACKGROUND OF THE INVENTION

### Field of the Invention

Example embodiments relate generally to a system and method for designing correlation-aware distributed caching and coded delivery in a content distribution network (CDN) in order to reduce a network load.

### Related Art

Content distribution networks (CDNs) face capacity and efficiency issues associated with an increase in popularity of on-demand audio/video streaming. One way to address these issues is through network caching and network coding. For example, conventional content distribution network (CDN) solutions employ algorithms for the placement of content copies among caching locations within the network. Conventional solutions also include cache replacement policies such as LRU (least recently used) or LFU (least frequently used) to locally manage distributed caches in order to improve cache hit ratios. Other conventional solutions use random linear network coding to transfer packets in groups, which may improve throughput in capacity-limited networks.

However, conventional network caching and network coding solutions do not consider the relative efficiency of caching and transmission resources. Moreover, conventional content delivery solutions do not exploit the possible combined benefits of network caching and network coding.

Conventional studies have shown that, in a cache-aided network, exploiting globally cached information in order to multicast coded messages that are useful to a large number of receivers exhibit overall network throughput that is proportional to the aggregate cache size, as described in at least the following documents: Roy Timo, Shirin Saeedi Bidokthi, Michele Wigger, and Bernhard Geiger. A rate-distortion approach to caching. preprint http://roytimo.wordpress.com/pub, 2015; M. Ji, A. M. Tulino, J. Llorca, and G. Caire. Caching and coded multicasting: Multiple groupcast index coding. In GlobalSIP, 2014, pages 881-885. IEEE, 2014; M. Ji, A. M. Tulino, J. Llorca, and G. Caire. On the average performance of caching and coded multicasting with random demands. In 11th International Symposium on Wireless Communications Systems (ISWCS), pages 922-926, 2014; M. Ji, A. M. Tulino, J. Llorca, and G. Caire. Order-optimal rate of caching and coded multicasting with random demands. arXiv:1502.03124, 2015; and Jaime Llorca, Antonia M Tulino, Ke Guan, and Daniel Kilper. Network-coded caching-aided multicast for efficient content delivery. In Proceedings IEEE International Conference on Communications (ICC), pages 3557-3562, 2013. Conventionally, the network may operate in two phases: a “placement phase” occurring at network setup, in which caches are populated with content from the library, followed by a “delivery phase” where the network is used repeatedly in order to satisfy receiver demands. A design of the placement and delivery phases forms what is referred to as a caching scheme.

In the conventional studies, each file in the library is treated as an independent piece of information, compressed up to its entropy, where the network does not account for additional potential gains arising from further compression of correlated content distributed across the network. Instead, during the placement phase, parts of the library files are cached at the receivers according to a properly designed caching distribution. The delivery phase consists of computing an index code, in which the sender compresses the set of requested files into a multicast codeword, only exploring perfect matches (“correlation one”) among parts of requested and cached files, while ignoring other correlations that exist among the different parts of the files. Therefore, a need exists to investigate additional gains that may be obtained by exploring correlations among the library content in both placement and delivery phases.

### SUMMARY OF INVENTION

At least one embodiment relates to a method of transmitting a plurality of data files in a network.

In one embodiment, the method includes, receiving, by at least one processor of a network node, requests from a plurality of destination devices for files of the plurality of data files, each of the requested files including at least one file-packet; building, by the at least one processor, a conflict graph using popularity information and a joint probability distribution of the plurality of date files; coloring, by the at least one processor, the conflict graph; computing, by the at least one processor, a coded multicast using the colored conflict graph; computing, by the at least one processor, a corresponding unicast refinement using the colored conflict graph and the joint probability distribution of the plurality of data files; concatenating, by the at least one processor, the coded multicast and the corresponding unicast; and transmitting, by the at least one processor, the requested files to respective destination devices of the plurality of destination devices.

In one embodiment, the building of the conflict graph includes, calculating a first vertex for a first file-packet requested by a first destination device, of the plurality of destination devices, the first vertex being one of a first virtual node and a first root node, the first virtual node being associated with a file packet requested by one of the destinations and stored in one of a destination cache of one of the plurality destination devices; calculating a second vertex for a second file-packet requested by a second destination device, of the plurality of destination devices, the second vertex being associated with a second virtual node and a second root node; and determining an edge between the first vertex and the second vertex in response to the first vertex and the second vertex belonging to a same cluster in the conflict graph and not representing a same file-packet.

In one embodiment, the method further includes caching content at each destination device based on the popularity information, wherein the calculation of the first vertex is accomplished using the joint probability distribution of the plurality of data files, wherein the determining the edge between the first vertex and the second vertex is further accomplished in response to the caching of the content at each destination device in response to the first vertex and the second vertex not representing a same file-packet.

In one embodiment, the building of the conflict graph further includes, checking a first cache of the first destination device to determine whether the second file-packet is available in the first cache, wherein the determining of the edge between the first and second vertex is performed in response to the second file-packet being available in the first cache; checking a second cache of the second destination device to determine whether the first file-packet is available in the second cache, wherein the determining of the edge between the first vertex and the second vertex is performed in response to the first file-packet being available in the second cache; and repeating the calculating, determining, caching and checking steps with pairs of additional vertices for additional requested file-packets for each of the plurality of destination devices.

At least another embodiment relates to a device.

In one embodiment, the device includes a non-transitory computer-readable medium with a program including instructions; and at least one processor configured to perform the instructions such that the at least one processor is configured to, receive requests from a plurality of destination devices for files of the plurality of data files, each of the requested files including at least one file-packet, build a conflict graph using popularity information and a joint probability distribution of the plurality of date files, color the conflict graph, compute a coded multicast using the colored conflict graph, compute a corresponding unicast refinement using the colored conflict graph and the joint probability distribution of the plurality of data files, concatenate the coded multicast and the corresponding unicast, and transmit the requested files to respective destination devices of the plurality of destination devices.

In one embodiment, the at least one processor is configured to build the conflict graph by, calculating a first vertex for a first file-packet requested by a first destination device, of the plurality of destination devices, the first vertex being one of a first virtual node and a first root node, the first virtual node being associated with a file packet requested by one of the destinations and stored in one of a destination cache of one of the plurality destination devices, calculating a second vertex for a second file-packet requested by a second destination device, of the plurality of destination devices, the second vertex being associated with a second virtual node and a second root node, and determining an edge between the first vertex and the second vertex in response to the first vertex and the second vertex belonging to a same cluster in the conflict graph and not representing a same file-packet.

In one embodiment, the at least one processor is further configured to, cache content at each destination device based on the popularity information, wherein the calculation of the first vertex is accomplished using the joint probability distribution of the plurality of data files, wherein the determining the edge between the first vertex and the second vertex is further accomplished in response to the caching of the content at each destination device in response to the first vertex and the second vertex not representing a same file-packet.

In one embodiment, the at least one processor is configured to build the conflict graph by, checking a first cache of the first destination device to determine whether the second file-packet is available in the first cache, wherein the determining of the edge between the first and second vertex is performed in response to the second file-packet being available in the first cache; checking a second cache of the second destination device to determine whether the first file-packet is available in the second cache, wherein the determining of the edge between the first vertex and the second vertex is performed in response to the first file-packet being available in the second cache; and repeating the calculating, determining, caching and checking steps with pairs of additional vertices for additional requested file-packets for each of the plurality of destination devices.

At least another embodiment relates to a network node.

In one embodiment, the network node includes, a memory with non-transitory computer-readable instructions; and at least one processor configured to execute the computer-readable instructions such that the at least one processor is configured to, receive requests from a plurality of destination devices for files of the plurality of data files, each of the requested files including at least one file-packet, build a conflict graph using popularity information and a joint probability distribution of the plurality of date files, color the conflict graph, compute a coded multicast using the colored conflict graph, compute a corresponding unicast refinement using the colored conflict graph and the joint probability distribution of the plurality of data files, concatenate the coded multicast and the corresponding unicast, and transmit the requested files to respective destination devices of the plurality of destination devices.

In one embodiment, the at least one processor is configured to build the conflict graph by, calculating a first vertex for a first file-packet requested by a first destination device, of the plurality of destination devices, the first vertex being one of a first virtual node and a first root node, the first virtual node being associated with a file packet requested by one of the destinations and stored in one of a destination cache of one of the plurality destination devices, calculating a second vertex for a second file-packet requested by a second destination device, of the plurality of destination devices, the second vertex being associated with a second virtual node and a second root node, and determining an edge between the first vertex and the second vertex in response to the first vertex and the second vertex belonging to a same cluster in the conflict graph and not representing a same file-packet.

In one embodiment, the at least one processor is further configured to, cache content at each destination device based on the popularity information, wherein the calculation of the first vertex is accomplished using the joint probability distribution of the plurality of data files, wherein the determining the edge between the first vertex and the second vertex is further accomplished in response to the caching of the content at each destination device in response to the first vertex and the second vertex not representing a same file-packet.

In one embodiment, the at least one processor is configured to build the conflict graph by, checking a first cache of the first destination device to determine whether the second file-packet is available in the first cache, wherein the determining of the edge between the first and second vertex is performed in response to the second file-packet being available in the first cache; checking a second cache of the second destination device to determine whether the first file-packet is available in the second cache, wherein the determining of the edge between the first vertex and the second vertex is performed in response to the first file-packet being available in the second cache; and repeating the calculating, determining, caching and checking steps with pairs of additional vertices for additional requested file-packets for each of the plurality of destination devices.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates a content distribution network, in accordance with an example embodiment;

FIG. 2 is illustrates a network element, in accordance with an example embodiment;

FIG. 3 illustrates a user cache configuration resulting from the proposed compressed library placement phase, in accordance with an example embodiment;

FIG. 4 illustrates a Correlation-Aware Random Aggregated Popularity Cache Encoder (CA-RAP), in accordance with an example embodiment;

FIG. 5 illustrates a Correlation-Aware Coded Multicast Encoder (CA-CM), in accordance with an example embodiment;

FIG. 6 illustrates a Correlation-Aware Coded Multicast Encoder (CA-CM) relying on a greedy polynomial time approximation of Correlation-Aware Cluster Coloring, in accordance with an example embodiment;

FIG. 7 illustrates a method of computing the caching distribution for a CA-CACM scheme that may be performed by a Random Aggregated Popularity Cache Encoder, in accordance with an example embodiment;

FIG. 8 is a flowchart illustrating a method performed by the CA-CM, in accordance with an example embodiment;

FIG. 9 is a flowchart illustrating a method performed by a greedy CA-CM, in accordance with an example embodiment;

FIG. 10A is a flowchart illustrating a method of a greedy polynomial time approximation of Correlation-Aware Cluster Coloring, in accordance with an example embodiment;

FIG. 10B is a flowchart illustrating a method of a greedy polynomial time approximation of Correlation-Aware Cluster Coloring, in accordance with an example embodiment;

FIG. 11 is another flowchart illustrating a method of a greedy polynomial time approximation of Correlation-Aware Cluster Coloring, in accordance with an example embodiment;

FIG. 12 is a flowchart of a method of Correlation-Aware Packet Clustering, in accordance with an example embodiment;

FIG. 13A is a flowchart illustrating a method of building a clustered conflict graph, in accordance with an example embodiment;

FIG. 13B is a flowchart illustrating a method of building a clustered conflict graph, in accordance with an example embodiment.

FIG. 14 illustrates a chromatic covering of a conflict graph, in accordance with an example embodiment.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures. Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium, such as a non-transitory storage medium. A processor(s) may perform the necessary tasks.

Specific structural and functional details disclosed herein are merely representative for purposes of describing example embodiments. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be any non-transitory storage medium such as magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

### General Methodology:

A purpose of some example embodiments relates to designing a correlation-aware scheme which may consist of receivers (destination devices) 200 storing content pieces based on their popularity as well as on their correlation with a rest of a library in a placement phase, and receiving compressed versions of the requested files according to an information distributed across a network 10 and joint statistics during a delivery phase.

In the correlation-aware caching scheme, termed CORRELATION-AWARE CACHE-AIDED CODED MULTICAST (CA-CACM), receivers 200 may store content pieces based on their popularity as well as on their correlation with a rest of the file library during the placement phase, and receive compressed versions of the requested files according to the information distributed across the network and their joint statistics during the delivery phase. Major purposes of the scheme may include the following.

A. Exploiting file correlations to store more relevant bits during a placement phase such that an expected delivery rate may be reduced, and
B. Optimally designing a coded multicast codeword based on joint statistics of the library files and the aggregate cache content during the delivery phase.

Additional refinements may be transmitted, when needed, in order to ensure lossless reconstruction of the requested files at each receiver.

Given an exponential complexity of CA-CACM, an algorithm may be provided which may approximate CA-CACM in polynomial time, and an upper bound may be derived on the an achievable expected rate.

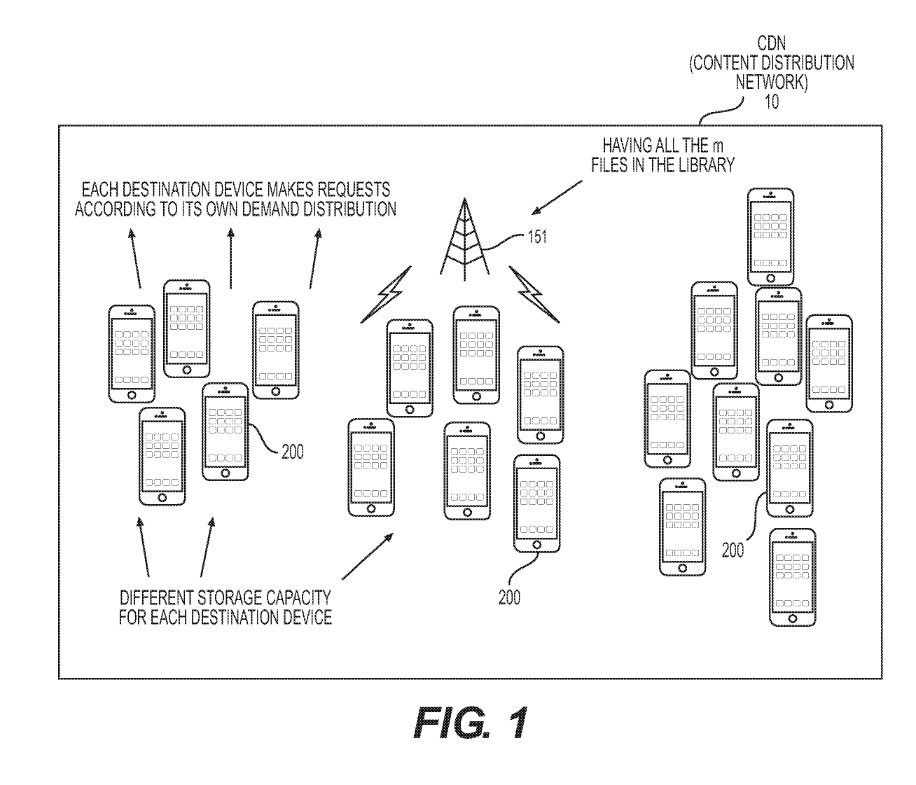

FIG. 1 shows a content distribution network, according to an example embodiment.

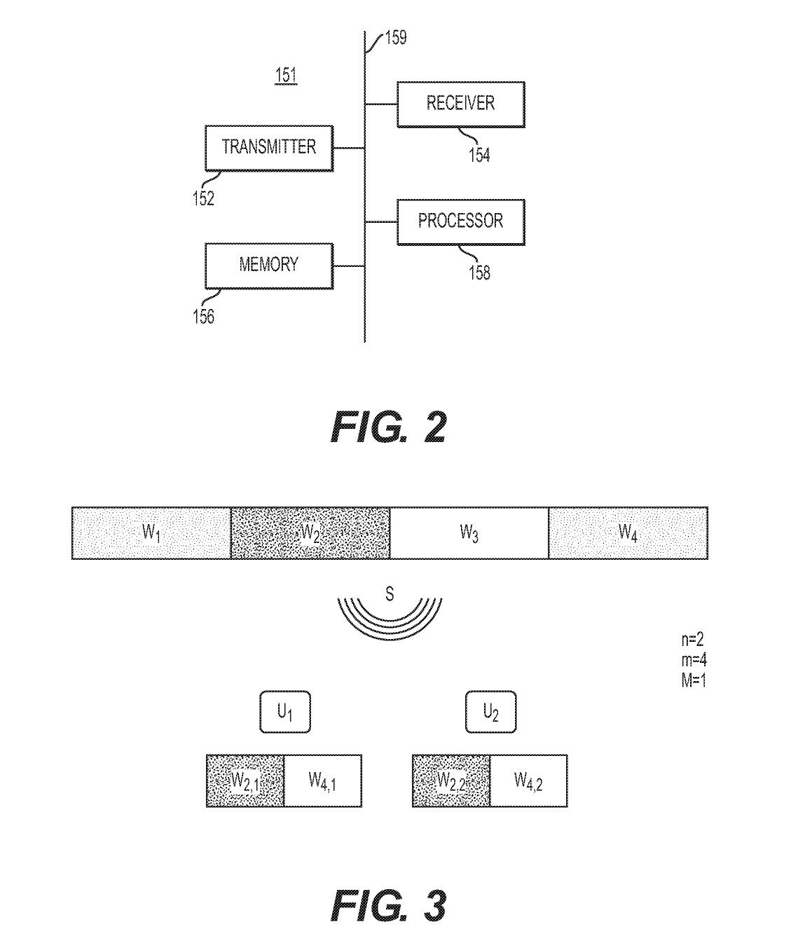

As shown in FIG. 1, a content distribution network (CDN) may include a network element 151 connected to a plurality of destination devices 200. The network element 151 may be a content source (e.g., a multicast source) for distributing data files (such as movie files, for example). The destination devices 200 may be end user devices requesting data from the content source. For example, each destination device 200 may be part of or associated with a device that allows for the user to access the requested data. For example, each destination device 200 may be a set top box, a personal computer, a tablet, a mobile phone, or any other device associated used for streaming audio and video. Each of the destination devices 200 may include a memory for storing data received from the network element 151. The structure and operation of the network element 151 and destination devices 200 will be described in more detail below with reference to FIGS. 2 and 3.

FIG. 2 is a diagram illustrating an example structure of a network element 151 according to an example embodiment. According to at least one example embodiment, the network element 151 may be configured for use in a communications network (e.g., the content distribution network (CDN) of FIG. 1). Referring to FIG. 2, the network element 151 may include, for example, a data bus 159, a transmitter 152, a receiver 154, a memory 156, and a processor 158. Although a separate description is not included here for the sake of brevity, it should be understood that each destination device 200 may have the same or similar structure as the network element 151.

The transmitter 152, receiver 154, memory 156, and processor 158 may send data to and/or receive data from one another using the data bus 159. The transmitter 152 may be a device that includes hardware and any necessary software for transmitting wireless signals including, for example, data signals, control signals, and signal strength/quality information via one or more wireless connections to other network elements in a communications network.

The receiver 154 may be a device that includes hardware and any necessary software for receiving wireless signals including, for example, data signals, control signals, and signal strength/quality information via one or more wireless connections to other network elements in a communications network.

The memory 156 may be any device or structure capable of storing data including magnetic storage, flash storage, etc.

The processor 158 may be any device capable of processing data including, for example, a special purpose processor configured to carry out specific operations based on input data, or capable of executing instructions included in computer readable code. For example, it should be understood that the modifications and methods described below may be stored on the memory 156 and implemented by the processor 158 within network element 151.

Further, it should be understood that the below modifications and methods may be carried out by one or more of the above described elements of the network element 151. For example, the receiver 154 may carry out steps of “receiving,” “acquiring,” and the like; transmitter 152 may carry out steps of “transmitting,” “outputting,” “sending” and the like; processor 158 may carry out steps of “determining,” “generating”, “correlating,” “calculating,” and the like; and memory 156 may carry out steps of “storing,” “saving,” and the like.

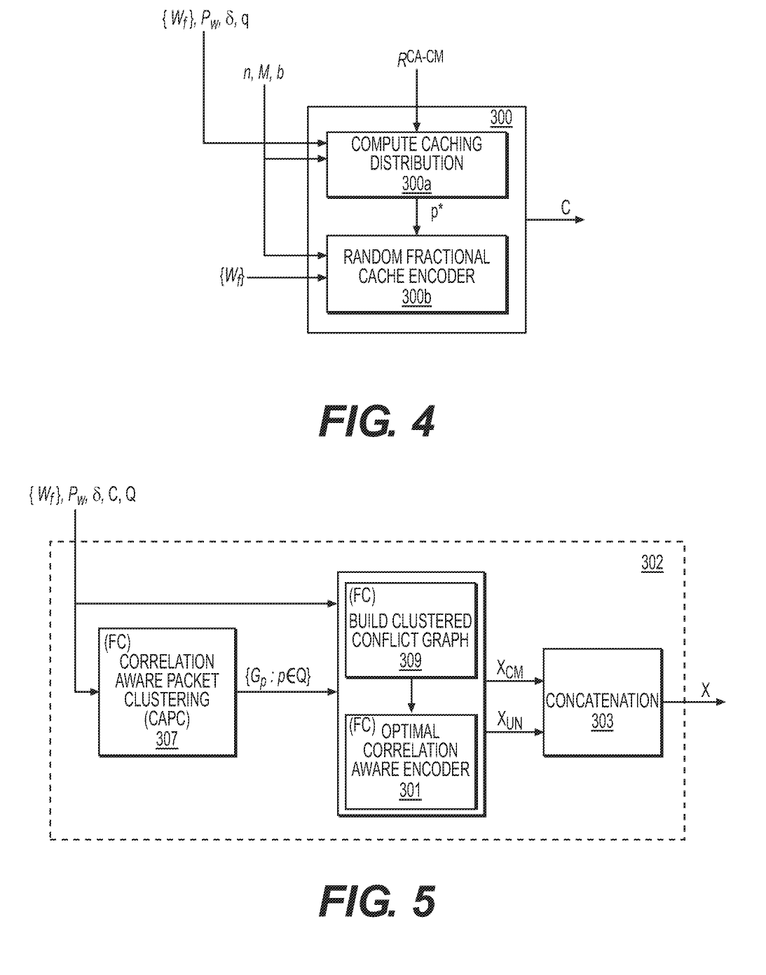

Major components of the CA-CACM scheme may include: i) a Correlation-Aware Random Aggregated Popularity Cache Encoder (CA-RAP) 300, shown in FIG. 4; and ii) a Correlation-Aware Coded Multicast Encoder (CA-CM) 302, shown in FIG. 5.

As shown in FIG. 4, the CA-RAP encoder 300 may be located in the processor 158 of the network node (sender/transmitter) 151, where the processor 158 may cause the CA-RAP encoder 300 to perform (for instance) the steps shown in the methods illustrated in FIG. 7 and Algorithm 1: Random Fractional Caching algorithm.

FIG. 5 illustrates a Correlation-Aware Coded Multicast Encoder (CA-CM) 302, in accordance with an example embodiment.

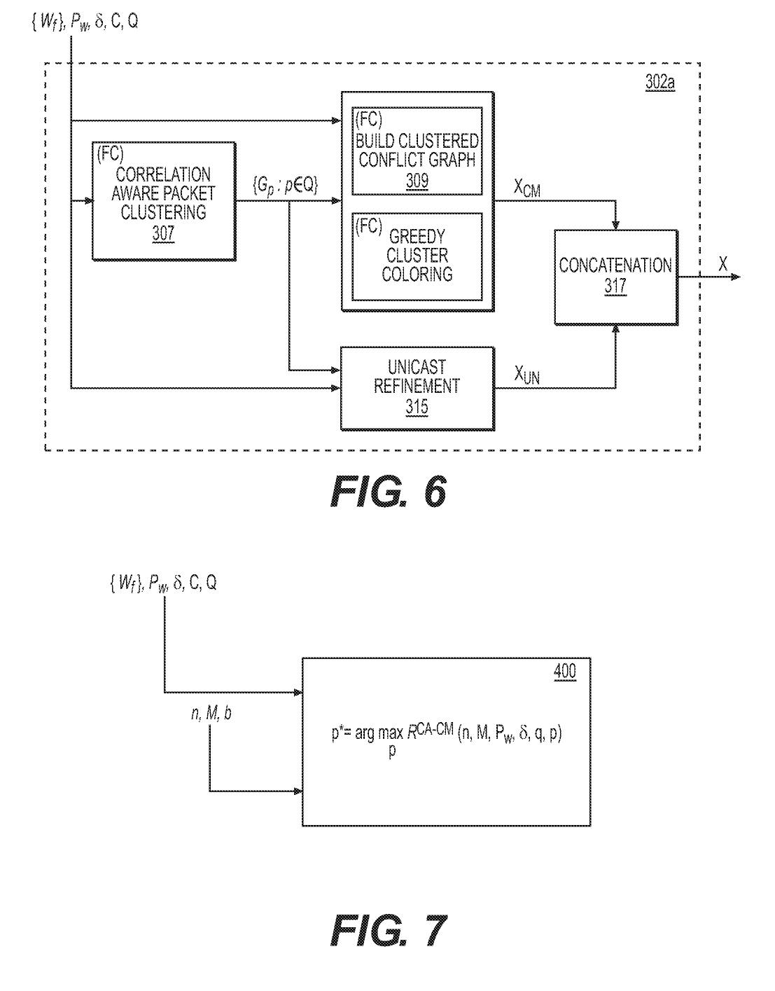

FIG. 6 illustrates an implementation of Correlation-Aware Coded Multicast Encoder (CA-CM) 302a relying on a greedy polynomial time approximation of Correlation-Aware Cluster Coloring, in accordance with an example embodiment. We refer to such implementation in FIG. 6 as (greedy) CA-CM encoder 302a, while we refer to the implementation of the CA-CM relying on the optimal Correlation-Aware Cluster Coloring as simply CA-CM encoder 302.

### Problem Formulation:

In a broadcast caching network 10 with one sender (a network element 151, such as a base station, for instance) connected to n receivers (i.e., destination devices 200), U={1, . . . , n} via a shared error-free multicast link. The sender 151 may access a file library F={1, . . . , m} composed of m files, each of entropy F bits, and each receiver 200 may have a cache (i.e., memory) of size MᵤF bits. Receivers 200 may request files in an independent and identically distributed (i.i.d.) manner according to a demand distribution q=(q₁, . . . , qₘ), where q_{f} denotes a probability of requesting file f∈F. The file library may be represented by a set of random binary vectors of length L≥F, {W_{f}∈F₂^{L}: f∈F}, whose realization is denoted by {W_{f}:f∈F}. Content files may be correlated, i.e., H(W_{f}|W_{f})≤F, ∀fᵢ, fⱼ∈F, and H(W₁, . . . , Wₘ)≤mF. Such correlations may be especially relevant among content files of a same category, such as episodes of a same TV show or a same-sporting event recording, which, even if personalized, may share common backgrounds and scene objects. Hence, the joint distribution of the library files, denoted by P_{F}, may not necessarily be the product of the file marginal distributions.

Network operations may generally occur in two major phases: 1) placement phase taking place at network setup, in which caches (non-transitory computer-readable medium) may be populated with content from the library, and 2) a delivery phase where the network may be used repeatedly in order to satisfy receiver 200 demands. A design of the placement and delivery phases forms may be jointly referred to as a “caching scheme.”

A goal of some of the example embodiments is to enjoy added gains that may be obtained by exploring correlations among the library content, in both placement and delivery phases. To that end, a multiple cache scenario may be used to use correlation-aware lossless reconstruction. The placement phase may allow for placement of arbitrary functions of a correlated library at the receivers 200, while the delivery phase may become equivalent to a source coding problem with distributed side information. A correlation-aware scheme may then consist of receivers 200 storing content pieces based on a popularity as well as on their correlation with the rest of the file library in the placement phase, and receiving compressed versions of the requested files may be accomplished according to information distributed across the network and joint statistics during the delivery phase.

### Theoretic Problem Formulation:

The term {Aᵢ} may denote a set of elements {Aᵢ:i∈I}, with being I the domain of index i. Using this notation, the following information-theoretic formulation of a caching scheme may be utilized, where initially a realization of the library {W_{f}} may be revealed to the sender. Cache Encoder 302:

At the sender 151, the processor 158 of the sender 151 may cause the cache encoder 302 to compute a content to be placed at the receiver caches by using a set of functions {Zᵤ:F₂^{mL}→F₂^{MF}:u∈U}, such that Z({W_{f}}) that may be the content cached at receiver U. A cache configuration {Zᵤ} may be designed jointly across receivers 200, taking into account global system knowledge such as the number of receivers and their cache sizes, the number of files, their aggregate popularity, and their joint distribution P_{F}. Computing {Zᵤ} and populating the receiver caches may constitute a “placement phase,” which may be assumed to occur during off-peak hours without consuming actual delivery rate.

Multicast Encoder 302:

Once the caches may be populated, the network 10 may be repeatedly used for different demand realizations. At each use of the network 10, a random demand vector f=(f₁, . . . , fₙ)∈Fⁿ may be revealed to the sender 151. Term f may have i.i.d components distributed according to q, where f=(f₁, . . . , fₙ). A multicast encoder may be defined by a fixed-to-variable encoding function X:Fⁿ×F₂^{mL}×F₂^{nMF}→F₂* (where F₂* may denote a set of finite length binary sequences), such that X(f,{W_{f}},{Zᵤ}) may be a transmitted codeword generated according to demand realization f, library realization {W_{f}}, cache configuration {Zᵤ}, and joint file distribution P_{F}.

Multicast Decoders 302:

Each receiver u c U may recover a requested file W_{f}_{ᵤ} using the received multicast codeword and its cached codeword, as Ŵ_{f}_{ᵤ}=(f,X,Zᵤ), where λᵤ:Fⁿ×F₂*×F₂^{MF}→F₂^{L} denotes the decoding function of receiver u.

The worst-case (over the file library) probability of error of the corresponding caching scheme may defined as follows.

$${P}_{e}^{( F )} = {sup}_{\{ {W}_{f} \text{:} f ∈ F \}} P ( {\hat{W}}_{{f}_{u}} \neq {W}_{{f}_{u}} ) .$$

An (average) rate of an overall caching scheme may be defined as follows.

$${R}^{( F )} = {sup}_{\{ {W}_{f} \text{:} f ∈ F \}} \frac{E [ J ( X ) ]}{F} . \qquad Equation 1$$

Where J(X) may denote a length (in bits) of the multicast codeword X.

For notational convenience, subsequent definitions may be provided under the hypothesis that Mᵤ=M for all u∈U={1, . . . , n}.

Definition 1:

A rate-memory pair (R,M) may be achievable if there exists a sequence of caching schemes for cache capacity (memory) M and increasing file size F such that lim_{F→∞}Pₑ^{(F)}=0, and limsup_{F→∞}R^{(F)}≤R.

Definition 2:

The rate-memory region may be the closure of the set of achievable rate-memory pairs (R,M). The rate-memory function R(M) may be the infimum of all rates R such that (R,M) may be in the rate-memory region for memory M.

A lower bound and an upper bound may be determined using a rate-memory function R(M), given in Theorems 1 and 2 respectively, and design a caching scheme (i.e., a cache encoder and a multicast encoder/decoder) may result in an achievable rate R close to the lower bound.

### Lower Bound:

In this section, under the assumption that Mᵤ=M for all u∈U={1, . . . , n}, a lower bound may be derived on the rate-memory function under uniform demand distribution using a cut-set bound argument on the broadcast caching-demand augmented graph. To this end let D^{(j)} denote the set of demands with exactly j distinct requests.

Theorem 1:

For the broadcast caching network 10 with n receivers 200, library size m, uniform demand distribution, and joint probability P_{W},

$$R ( M ) \geq {liminf}_{F \to ∞} {max}_{𝓁 ∈ \{ 1 , … , γ \}} {P}_{𝓁} \frac{{[ H ( \{ {W}_{f} : f ∈ F \} ) - 𝓁 MF ]}^{+}}{⌊ \frac{m}{𝓁} ⌋ F}$$

Where γ=min{n,m}, [symbol] =P(d∈ [symbol] D^{(j)}) and H({W_{f}:f∈F}) is the entropy of the entire library.

### Correlation-Aware Cache-Aided Coded Multicast (CA-CACM) Method:

The CA-CACM method may be a correlation-aware caching scheme, which may be an extension of a fractional Correlation-Aware Random Aggregated Popularity-based (RAP) caching policy followed by a Chromatic-number Index Coding (CIC) delivery policy, which has been previously disclosed by these two patent documents that are hereby incorporated in their entirety into this application: U.S. pub. app. 2015/0207881, “Devices and Methods for Network-Coded and Caching-Aided Content Distribution,” by Antonia Tulino, et al; and U.S. pub. app. 2015/0207896, “Devices and Methods for Content Distribution in a Communications Network,” by Jaime Llorca, et al. In this method, both the cache encoder 300 and the multicast encoder 302 are “correlation-aware” in the sense that they may be designed according to the joint distribution P_{W}, in order to exploit the correlation among the library files. First, consider the following motivating example illustrated in FIG. 3. We refer to the cache encoder 300 proposed in this method as Correlation-Aware Random Aggregated Popularity-based (CA-RAP) cache encoder (which is illustrated in FIG. 4) and to the multicast encoder 302 as Correlation-Aware Coded Multicast (CA-CM) encoder (which is illustrated in FIG. 5). A greedy polynomial time implementation of the CA-CM encoder 302 is illustrated in FIG. 6 and we refer to it as the (greedy) CA-CM encoder 302a.

### Example 1

Consider a file library with m=4 uniformly popular files {W₁, W₂, W₃, W₄} each with entropy F bits as in Fig. The pairs {W₁, W₂} and {W₃, W₄} may be assumed to be independent, while correlations exist between W₁ and W₂, and between W₃ and W₄. Specifically, H(W₁|W₂)=H(W₂|W₁)=F/4 and H(W₃|W₄)=H(W₄|W₃)=F/4. The sender may be connected to n=2 receivers {u₁,u₂} with cache size Mᵤ=1. While a correlation-unaware scheme (such as the schemes described in the above-reference patent documents: U.S. pub. app. 2015/0207881 and U.S. pub. app. 2015/0207896) would first compress the files separately and then cache ¼^{th} of each file at each receiver, existing file correlations may be exploited to cache the more relevant bits. For example, the files W₂ and W₄ may be split into two parts {W_{2,1},W_{2,2}} and {W_{4,1},W_{4,2}} each with entropy F/2, and cache {W_{2,1},W_{4,1}} at u₁ and {W_{2,2},W_{4,2}} at u₂, as shown in FIG. 3. During the delivery phase, considering the worst case demand, e.g., f=(W₃,W₁), the sender 151 first may multicast the XOR of the compressed parts W_{2,1} and W_{4,2}. Refinement segments, with refinement rates H(W₃|W₄) and H(W₁|W₂) may then be transmitted to enable lossless reconstruction, resulting in a total rate R=1. Note that a correlation-unaware scheme would need a total rate R=1.25 regardless of the demand realization.

### Correlation-Aware Random Popularity Cache Encoder (CA-RAP) 300:

The CA-RAP cache encoder 300 may be a correlation-aware random fractional random cache encoder, that has a key differentiation from the cache encoder RAP, introduced in the two patent documents cited above (U.S. pub. app. 2015/0207881, and U.S. pub. app. 2015/0207896), where the fractions of files may be chosen to be cached according to both their popularity as well as their correlation with the rest of the library. Similar to the cache encoder RAP, each file may be partitioned into B equal-size packets, with packet b∈[B] of file f∈[m] denoted by W_{f,b}. The cache content at each receiver 200 may be selected according to a caching distribution, pᵤ=(p_{u,1}, . . . , p_{u,m}) with 0≤p_{u,f}≤1/M ∀f∈[m] and Σ_{f=1}^{m}p_{u,f}=1, which may be optimized to minimize the rate of the corresponding index coding delivery scheme. For a given caching distribution pᵤ, each receiver may cache a subset of p_{u,f}MᵤB distinct packets from each file f∈[m], independently at random. Denote by C={C₁, . . . , Cₙ}, the packet-level cache configuration, where Cᵤ denotes the set of file-packet index pairs, (f,b), f∈[m], b∈[B], cached at receiver u. In Example 1, B=2, the caching distribution may correspond to p_{W}_{₂}=p_{W}_{₄}=½, p_{W}_{₁}=p_{W}_{₃}=0, and the packet-level cache configuration may be C={{(2,1),(4,1)},{(2,2),(4,2)}}.

While the caching distribution of a correlation-unaware scheme prioritizes the caching of packets according to the aggregate popularity distribution (as disclosed in the above-referenced patent documents: U.S. pub. app. 2015/0207881 and U.S. pub. app. 2015/0207896), the CA-RAP 300 caching distribution may account for both the aggregate popularity and the correlation of each file with the rest of the library when determining the amount of packets to be cached from each file.

The caching distribution may be optimally designed to minimize the rate of the corresponding correlation-aware delivery scheme as expressed in Equation 1, while taking into account global system parameters (n,m,{Mᵤ},q,P_{W}).

FIG. 7 illustrates a method of computing the caching distribution for a CA-CACM scheme that may be performed by the CA-RAP 300, in accordance with an example embodiment.

Based on the computed caching distribution, the Random Fractional Cache Encoder 300b (see FIG. 4) proposed and described in the two patent documents cited above (U.S. pub. app. 2015/0207881, and U.S. pub. app. 2015/0207896), may fill in a cache (memory 156) of a user (mobile device 200) with properly chosen packets of library files, using the Random Fractional Caching algorithm described below in Algorithm 1 (below), where each data file ‘f’ may be divided into B equal-size packets, represented as symbols of F_{2F/B} for finite F/B and belongs to library ‘F’.

Algorithm 1: Random Fractional Caching algorithm

1 for f ∈ F →
2 Each user u caches a subset of
p_{f,u}MᵤB distinct packets of file f
uniformly at random;
3 endfor
4 C = {C_{u,f}, with u = 1,...,n, and f = 1,...,m};
5 return( C );
end Caching algorithm

Algorithm C_{u,f} may denote a set of packets stored at user u for file f and C the aggregate cache configuration.

In Algorithm 1, ‘pᵤ=└P_{u,1}, . . . , p_{u,m}┘’ may be the caching distribution of the ‘u’ destination device 200, where Σ_{f=1}^{m}p_{f,u}=1, ∀u with u=1, . . . , n, and 0≤p_{f,u}≤1/Mᵤ, ∀f=1, . . . , m, u=1, . . . , n, ‘m’ is the number of files hosted by the network element 151, and ‘Mᵤ’ may be the storage capacity of the cache at destination device ‘u’ (i.e., destination device 200) and M_{u,f}=p_{f,u}MᵤB may denote the packets of file f cached at user u.

Furthermore, the randomized nature of Algorithm 1 allows network element 151 to perform operations such that, if two destinations caches the same number of packets for a given file T, then each of the two destination device 200 caches different packets of the same file ‘f’. More details on Algorithm 1 and its implementation are disclosed in the two above-referenced patent documents: U.S. pub. app. 2015/0207881, and U.S. pub. app. 2015/0207896.

### Correlation-Aware Coded Multicast Encoder (CA-CM) 302:

For a given demand realization f, the packet-level demand realization may be denoted by Q=[Q₁, . . . , Qₙ], where Qᵤ denotes the file-packet index pairs (f,b) associated with the packets of file W_{f}_{ᵤ} requested, but not cached, by receiver u.

The CA-CM encoder 302 may capitalize on additional coded multicast opportunities that may arise from incorporating cached packets that are, not only equal to, but also correlated with the requested packets into the multicast codeword. The CA-CM encoder 302 may operate by constructing a clustered conflict graph, and computing a linear index code from a valid coloring of the conflict graph, as described in the following.

Valid coloring of a graph is an assignment of colors to the vertices of the graph such that no two adjacent vertices may be assigned a same color.

### Correlation-Aware Packet Clustering:

For each requested packet W_{f,b}, (f,b)∈Q, the correlation-aware packet clustering procedure computes a δ-ensemble G_{f,b}, where G_{f,b} may be the union of W_{f,b} and the subset of all cached and requested packets that are δ-correlated with W_{f,b}, as per the following definition.

A valid coloring of a graph may be an assignment of colors to the vertices of the graph such that no two adjacent vertices may be assigned the same color.

Definition 2 (δ-Correlated Packets):

For a given threshold δ≤1, packet W_{f,b} may be δ-correlated with packet W_{f,b}, if H(W_{f,b},W_{f′,b′})≤(1+δ)F bits, for all f,f′∈[m] and b,b′∈[B].

This classification (clustering) may be a first step for constructing the clustered conflict graph.

### Correlation-Aware Cluster Coloring:

Let the clustered conflict graph H_{C,Q}=(V,E) be constructed as follows:

The vertex set V=\hat{V}∪\tilde{V} may be composed of root nodes \hat{V} and virtual nodes \tilde{V}.

Root Nodes:

There may be a root node v∈\hat{V} for each packet requested by each receiver, uniquely identified by the pair {ρ(v),μ(v)}, with ρ(v) denoting the packet identity and μ(v) the receiver requesting it.

Virtual Nodes:

For each root node v∈\tilde{V}, all the packets in the δ-packet-ensemble G_{ρ(v)} other than ρ(v) may be represented as virtual nodes in \tilde{V}. Virtual node v′∈\tilde{V} may be identified as having v as a root note, with the triplet {ρ(v′),μ(v),r(v′)}, where ρ(v′) indicates the packet identity associated to vertex v′, μ(v) indicates the receiver requesting ρ(v), and r(v′)=v may be the root of the δ-packet-ensemble that v′ belongs to. A set of vertices may be denoted as Kᵥ⊆V that contain root node v∈\tilde{V} and virtual nodes may correspond to the packets in its δ-packet-ensemble G_{ρ(v)}, where Kᵥ may denoted the cluster of root node v.

Edge set E:

For any pair of vertices v₁,v₂∈V, there may be an edge between v₁ and v₂ in E if 1) ρ(v₁)≠ρ(v₂), 2) packet ρ(v₁)∉C_{μ(v}_{₂}₎ or packet ρ(v₂)∉C_{μ(v}_{₁}₎, and 3) if both v₁ and v₂ are in Kᵥ, v∈\hat{V}.

Definition 3 (Valid Cluster Coloring):

Given a valid coloring of the clustered conflict graph H_{C,Q}, a valid cluster coloring of H_{C,Q} may consist of assigning one color to each cluster Kᵥ, Δv∈\hat{V}, from the colors assigned to the vertices inside each cluster.

The above definition means that given a valid coloring of H_{C,Q}, a valid cluster coloring of H_{C,Q} may consist of assigning to each cluster Kᵥ, Δv∈\hat{V}, one of the colors assigned to the vertices inside that cluster. For each color in the cluster coloring, only the packets with the same color as the color assigned to their corresponding cluster, are XORed together and multicasted to the users. Using its cached information and the received XORed packets, each receiver may be able to reconstruct a (possibly) distorted version of its requested packet, due to the potential reception of a packet that is δ-correlated with its requested one. The encoder may transmit refinement segments, when needed, to enable lossless reconstruction of the demand at each receiver 200. The coded multicast codeword results from concatenating: 1) for each color in the cluster coloring, the XOR of the packets with the same color, and, 2) for each receiver 200, if needed, the refinement segment. The CA-CM encoder 302 may select the valid cluster coloring corresponding to the shortest coded multicast codeword (e.g. resulting the achievable code with minimum rate).

It should be noted that if the correlation is not considered or non-existent, the clustered conflict graph may be equivalent to a conventional index coding conflict graph (as disclosed in the above-cited patent documents (U.S. pub. app. 2015/0207881 and U.S. pub. app. 2015/0207896) that have been hereby been incorporated by reference in their entirety. In other words, a subgraph of H_{C,Q} resulting from may consider only the root nodes \hat{V}.

A number of colors in the cluster coloring chosen by CA-CM encoder 302 may always be smaller than or equal to a chromatic number of the conventional index coding conflict graph (where a chromatic number of a graph is a minimum number of colors over all valid colorings of the graph). Such a reduction in a number of colors may be obtained by considering correlated packets that are cached in the network, which possibly results in less conflict edges and provides more options for coloring each cluster. Intuitively, CA-CM encoder 302 allows for the requested packets that had to be transmitted by themselves, otherwise to be represented by correlated packets that may be XORED together with other packets in the multicast codeword.

### Example 2

In order to provide an example of the proposed scheme, consider a caching network with three receivers, U={1,2,3} and six files F={A,A′,B,B′,C,C′}. Each receiver 200 may have cache size if =2 and files may be divided into B=6 packets (e.g. A={A₁, A₂, . . . , A₆}). Assume that, for a given δ, packets Aᵢ, A_{i′}, and Bᵢ, B_{i′}, and C₁, C_{1′}, ∀j∈{1, . . . , 6} may be δ-correlated, and all other packet pairs may be independent. The caching distribution may be

$$p = \{ \frac{1}{3} , 0 , \frac{1}{4} , \frac{1}{12} , \frac{1}{6} , \frac{1}{6} \} ,$$

which means 4 packets of A, 0 packets of A′, 3 packets of B, 1 packet of B′, 2 packets of C and 2 packets of C′ may be cached at each user. Assume the following cache realization C, as shown below.
C₁={A₁,A₂,A₃,A₄,B₁,B₂,B₃,B_{4′},C₁,C₂,C_{5′},C_{6′}}
C₂={A₃,A₄,A₅,A₆,B₄,B₅,B₆,B_{1′},C₃,C₄,C_{1′},C_{2′}}
C₃={A₁,A₂,A₅,A₆,B₁,B₂,B₆,B_{3′},C₅,C₆,C_{3′},C_{4′}}

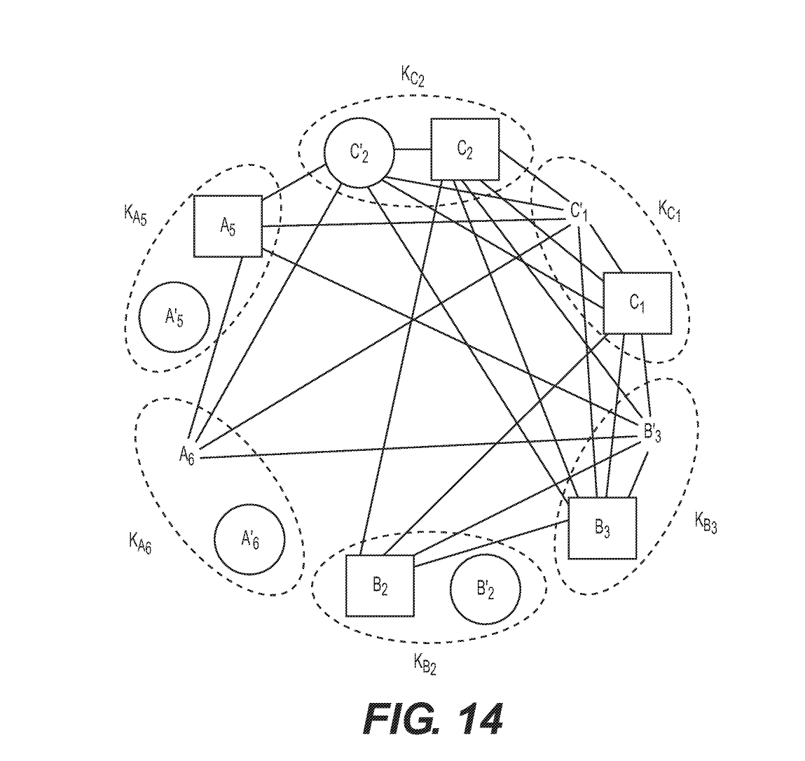

For demand realization f=(A,B,C), the packet-level demand configuration may be Q={A₅,A₆,B₁,B₂,B₃,C₁,C₂,C₃,C₄}, which, based on the cache configuration, may reduce to root set \hat{V}={A₅,A₆,B₂,B₃,C₁,C₂}. The corresponding conflict graph H_{C,Q} with vertices V={A₅,A_{5′},A₆,A_{6′},B₂,B_{2′},B₃,B_{3′},C₁,C_{1′},C₂,C_{2′}} is shown in FIG. 14. Correlation-aware chromatic cluster covering results in codeword {A₅⊕B₂,A₆,B_{3′}⊕C_{1′},C₂}. With the covering of the graph, additional transmissions may be required through Uncoded Refinement. For example, since receiver 2 may receive B_{3′} instead of requested packet B₃, an additional transmission at rate H (B₃|B_{3′}) may enable receiver 2 to recover B₃ without distortion. The overall normalized transmission rate may be shown as follows.

4F/6+H(B₁|B_{1′})+H(B₃|B_{3′})+H(C₁|C_{1′})+H(C₃|C_{3′})+H(C₄|C_{4′})=(4+5δ)F/6 bits

The cache-aided code multicast schemes provided in the two above-identified patent documents (U.S. pub. app. 2015/0207881 and U.S. pub. app. 2015/0207896) disregard the correlations among file packets, resulting in codeword {A₅⊕B₂,A₆⊕B₂,B₃,C₁,C₂,C₃,C₄} with rate 7F/6 bits.

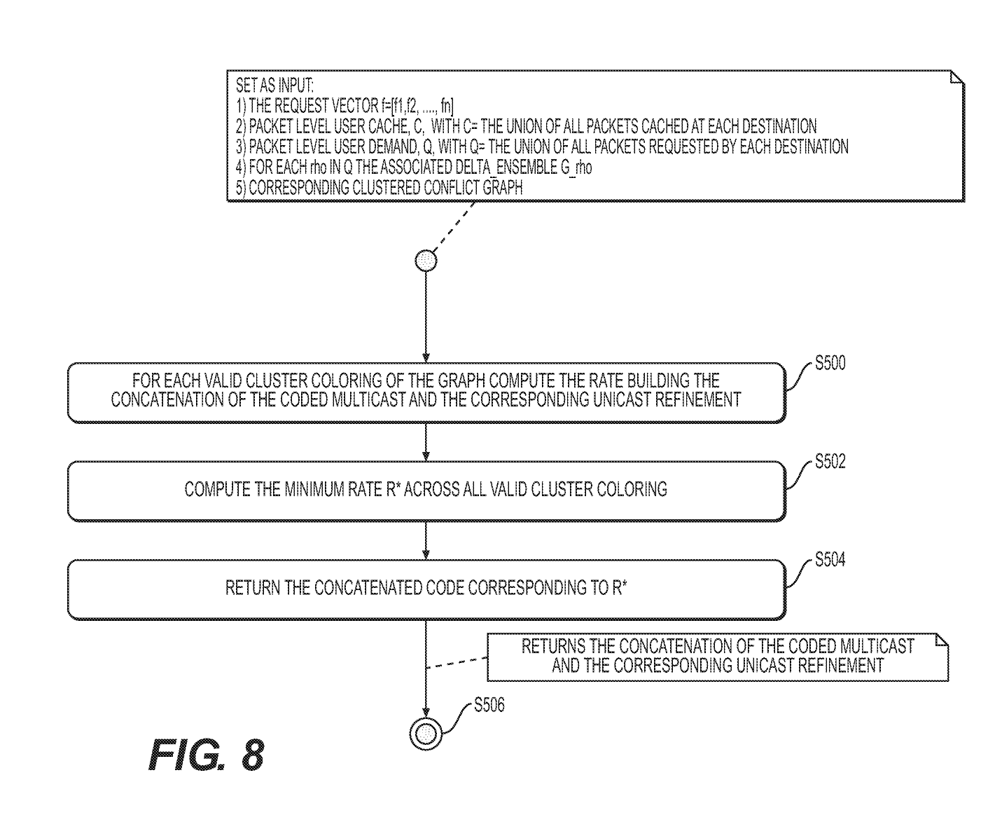

FIG. 8 is a flowchart illustrating a method performed by a CA-CM encoder 302, in accordance with an example embodiment. In particular, the CA-CM encoder 302 may be included in the processor 158 of the network element 151 (FIG. 2), where the CA-CM encoder 302 may include instructions for the processor 158 to perform these method steps, as described in the following. CA-CM encoder 302 takes as input:
The request vector f=(fₜ, . . . , fₙ);
The packet level user cache configuration, C={C₁, . . . , Cₙ} with C=the union of all packets cached at each destination where Cᵤ denotes the set of file-packet index pairs, (f,b), f∈[m], b∈[B], cached at receiver u.
The packet level user demand, Q=[Q₁, . . . , Qᵤ], with Q=the union of all packets requested by each destination i.e. where Qᵤ denotes the file-packet index pairs (f,b) associated with the packets of file W_{f}_{ᵤ} requested, but not cached, by receiver u,
The correlation threshold, δ,
The joint distribution of the library,

Using the above inputs, in step S500, the processor 158 may cause the CA-CM encoder to generate for each packet rho in Q the associated delta_ensemble, G_{ρ(v)}, denoted with G_rho in the flowchart. Using the output of step S500, CA-CM encoder builds the corresponding clustered conflict graph in S604. In step S508, for each valid cluster coloring of the graph computes the rate, R, needed to satisfies user's demands building the concatenation of the coded multicast and the corresponding unicast refinement. Across all the rate, R, computed in step S508 for each valid cluster coloring, in step S510, the processor 158 may cause the CA-CM encoder to compute the minimum rate, R*, and identifies the corresponding valid coloring. Then in step S512 the processor 158 may cause the CA-CM encoder to compute the concatenated code corresponding to valid coloring associated to R* and in S514 it returns as output the concatenation of the coded multicast and the corresponding unicast refinement.

Given an exponential complexity of Correlation-Aware Coloring in the CA-CM encoder 302, any polynomial time that may provide a valid cluster coloring may be applied. In the following, an algorithm which approximates the CA-CACM encoder 302 may be provided in polynomial time, where an upper bound on the achievable expected rate may be derived. We refer to it as (greedy) the CA-CACM encoder 302a.

### Greedy Cluster Coloring (GClC):

Given that graph coloring, and by extension cluster coloring, is NP-Hard, a greedy polynomial time approximation of Correlation-Aware Cluster Coloring which we refer to as Greedy Cluster Coloring (GClC) may further be implemented, where a polynomial-time approximation to the cluster coloring problem may be used. GClC may extend an existing Greedy Constraint Coloring (GCC) scheme (beyond what was disclosed in the above-referenced patent documents that have hereby been incorporated by reference in their entirety: U.S. pub. app. 2015/0207881, and U.S. pub. app. 2015/0207896), in order to account for file correlation in cache-aided networks and that consist of a combination of two coloring schemes, such that the scheme resulting in the lower number of colors (i.e., shorter multicast codeword) may be chosen. Uncoded refinement segments are transmitted to ensure lossless reconstruction of the demand.

Algorithm 1: Random Fractional Caching algorithm

```
  1: while [symbol]     ≠ ∅ do
  2:  Pick any root node [symbol]     ∈ [symbol]
  3:  Sort [symbol]     in decreasing order of receiver label size⁵, such
      that for [symbol]   ₜ, [symbol]  ₜ₊₁ ∈ [symbol]    ,
      |{μ( [symbol]  ₜ ), η( [symbol]  ₜ )}| ≥ |{μ( [symbol]  ₜ₊₁), η( [symbol]  ₜ₊₁)}| where [symbol]   ₜ
      denotes the t^{th} vertex in the ordered sequence.
  4:  t = 1
  5:  while t ≤ | [symbol]   | do
  6:  Take [symbol]   ₜ ∈ [symbol]    ; Let [symbol]     = { [symbol]   ₜ}
  7:  for all [symbol]     ∈ [symbol]   \{ [symbol]    ∪ [symbol]    } do
  8:  if {There is no edge between [symbol]     and [symbol]    } ∧
          {{μ( [symbol]   ), η( [symbol]   )} = {μ( [symbol]  ₜ), η( [symbol]  ₜ)}} then
  9: [symbol]     = [symbol]     ∪ { [symbol]  }
10:  end if
11:  end for
12:   ${𝓋}_{t}^{*} = {arg max}_{\{ {𝓋}_{τ} \text{:} τ = 1 , … , t \}} \vert {I}_{{𝓋}_{τ}} \vert$
13:  if | [symbol]   | ≥ |{μ( [symbol]  ₜ), η( [symbol]  ₜ)}| or t = | [symbol]   | then
14: [symbol]     = [symbol]
15:  t = | [symbol]   | + 1
16:  else
17:  t = t + 1
18:  end if
19:  end while
20:  Color all vertices in [symbol]     with an unused color.
21: [symbol]     = {r( [symbol]   ): [symbol]    ∈ [symbol]    }
22: [symbol]     = { [symbol]    ∈ [symbol]   :∃ [symbol]    ∈ [symbol]    ,
      {μ( [symbol]   ) = μ( [symbol]   )} ∧ {ρ( [symbol]   ) ∈ [symbol]    }}
23:   $\hat{𝒱} ← \hat{𝒱} \backslash 𝒥 ⋃ \hat{𝒥} , 𝒱 ← 𝒱 \backslash {⋃}_{\hat{𝓋} ∈ 𝒥 ⋃ \hat{𝒥}} {𝒦}_{\hat{𝓋}}$
24: end while
```

In GClC, it may be assumed that any vertex (root node or virtual node) v∈V may be identified by the triplet {ρ(v),μ(v),r(v)}, which may be uniquely specified by a packet identity associated with v and by the cluster to which v belongs. Specifically, given a vertex v∈K_{\hat{v}}, then ρ(v) may indicate the packet identity associated with vertex v, while μ(v)=μ(\hat{v}) and r(v)=\hat{v}. Further define η(v)={u∈U: ρ(v)∈Cᵤ} for any v∈V. The unordered set of receivers {μ(v),η(v)}, corresponding to the set of receivers either requesting or caching packet ρ(v), may be referred to as the receiver label of vertex v.

GClC consists of two Algorithms: GClC₁ and GClC₂

Algorithm GClC₁ may start from a root node \hat{v}∈\hat{V} among those not yet selected, and searches for the node vₜ∈K_{\hat{v}} which may form the largest independent set I with all the vertices in V having its same receiver label (where an independent set may be a set of vertices in a graph, where no two of which may be adjacent). Next, vertices in set I are assigned the same color (see lines 20-23).

Algorithm GClC₂ may be based on a correlation-aware extension of GCC₂ (as disclosed in the two above-referenced patent documents that are hereby been incorporated by reference in their entirety: U.S. pub. app. 2015/0207881, and U.S. pub. app. 2015/0207896), and may correspond to a generalized uncoded (naive) multicast: For each root node \hat{v}∈\hat{V}, whose cluster may have not yet been colored, only the vertex vₜ∈K_{\hat{v}} whom may be found among the nodes of more clusters, i.e., correlated with a larger number of requested packets, may be colored and its color may be assigned to K_{\hat{v}} and all clusters containing vₜ.

For both GClC₁ and GClC₂, when the graph coloring algorithm terminates, only a subset of the graph vertices, V, may be colored such that only one vertex from each cluster in the graph may be colored. This is equivalent to identifying a valid cluster coloring where each cluster may be assigned the color of its colored vertex.

Between GClC₁ and GClC₂, the cluster coloring resulting in the lower number of colors is chosen. For each color assigned during the coloring, the packets with the same color are XORed together, and multicasted

Note that the above greedy algorithm may be applied to completely herogenneus settings where each user 200 may have its own cache size, its own demand distribution and request an arbitrary number of files.

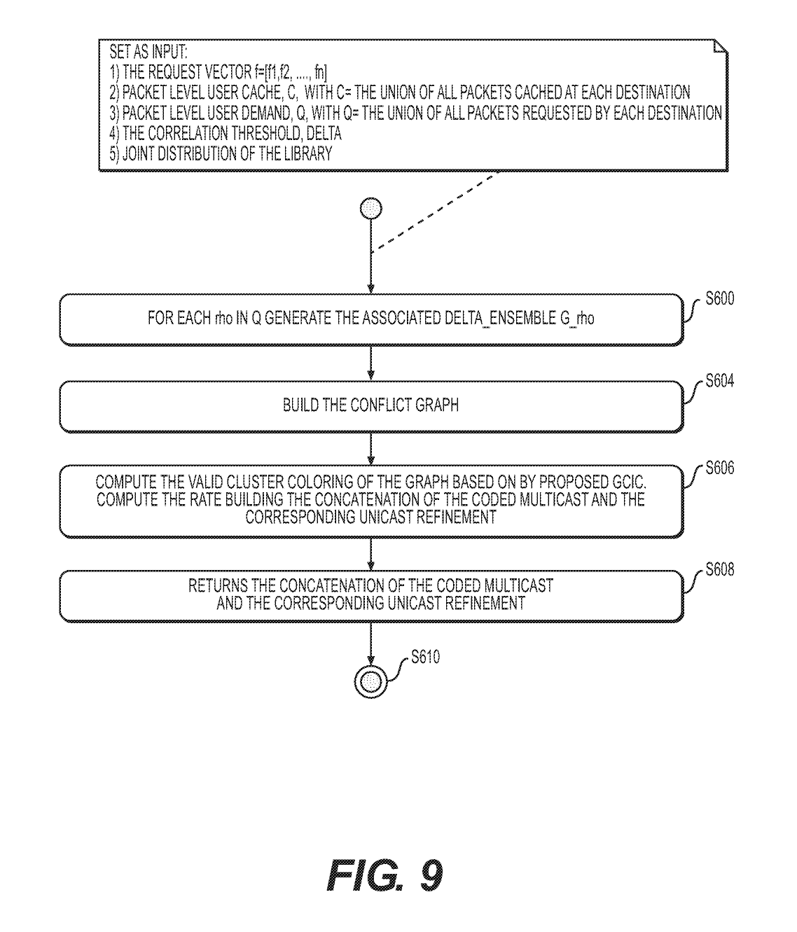

FIG. 9 is a flowchart illustrating a method performed by the (greedy) CA-CM encoder 302a when the Greedy Cluster Coloring (GClC), is implemented, in accordance with an example embodiment. In particular, the CA-CM encoder 302a may be included in the processor 158 of the network element 151 (FIG. 2), where the CA-CM encoder 302a may include instructions for the processor 158 to perform these method steps, as described herein. The CA-CM encoder 302a takes as input:
The request vector f=(f₁, . . . , fₙ);
The packet level user cache configuration, C={C₁, . . . , Cₙ} with C=the union of all packets cached at each destination where Cᵤ denotes the set of file-packet index pairs, (f,b), f∈[m], b∈[B], cached at receiver u.
The packet level user demand, Q=[Q₁, . . . , Qₙ], with [symbol] =the union of all packets requested by each destination i.e. where Qᵤ denotes the file-packet index pairs (f,b) associated with the packets of file W_{f}_{ᵤ} requested, but not cached, by receiver u,
The correlation threshold, δ,
The joint distribution of the library,

Using the above inputs, the CA-CM encoder 302a generates in step S600, for each packet rho in Q, generates the associated delta_ensemble, G_{ρ(v)}, denoted with G_rho in the flowchart. Using the output of step S600, the processor 158 may cause the CA-CM encoder 302a to build the conflict graph in S604 and in S606 first it computes a valid cluster coloring of the graph based on by proposed GClC and then it computes the rate associated building the concatenation of the coded multicast and the corresponding unicast refinement. Finally, in S608 the processor 158 may cause the CA-CM encoder in 302a to return the concatenation of the coded multicast and the corresponding unicast refinement

Note that the above delivery technique may be applied to herogenneus settings where each user (mobile device) 200 may have its own cache size, its own demand distribution, and the user 200 may request an arbitrary number of files.

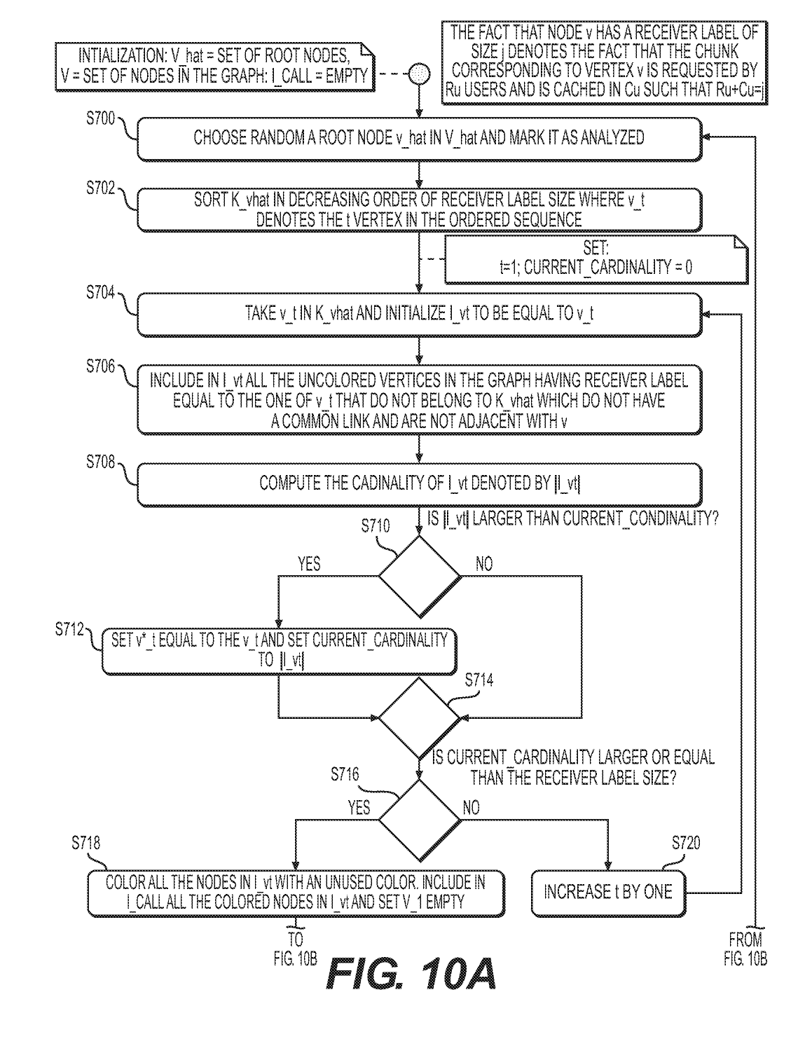

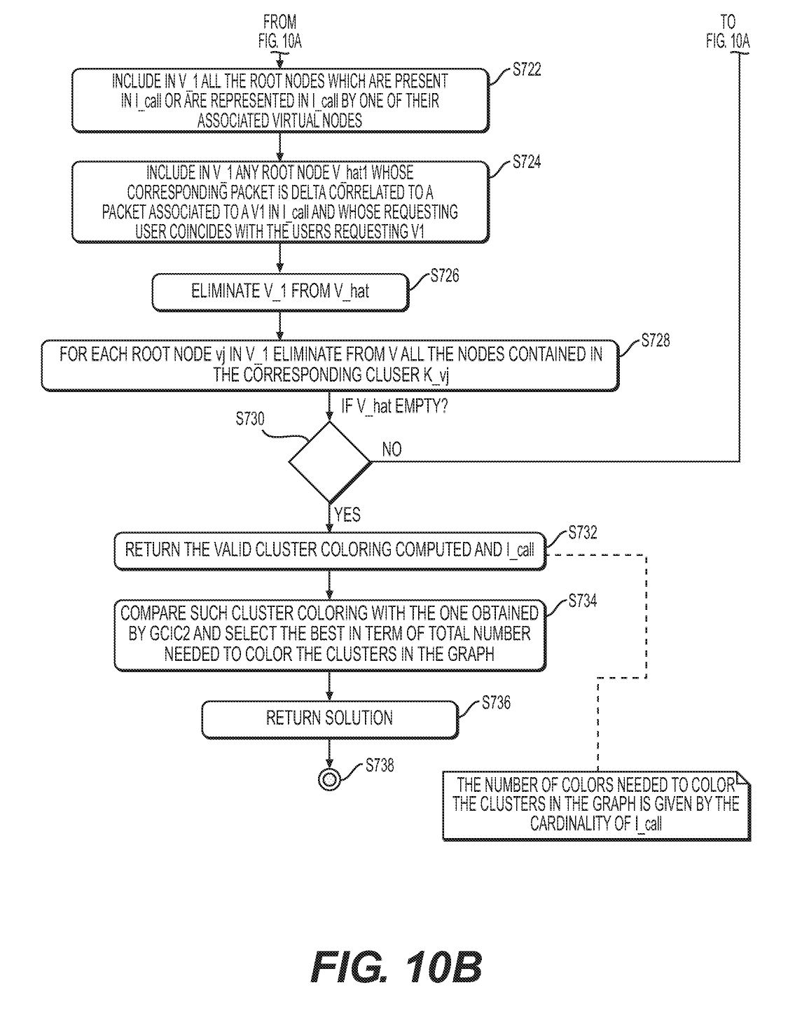

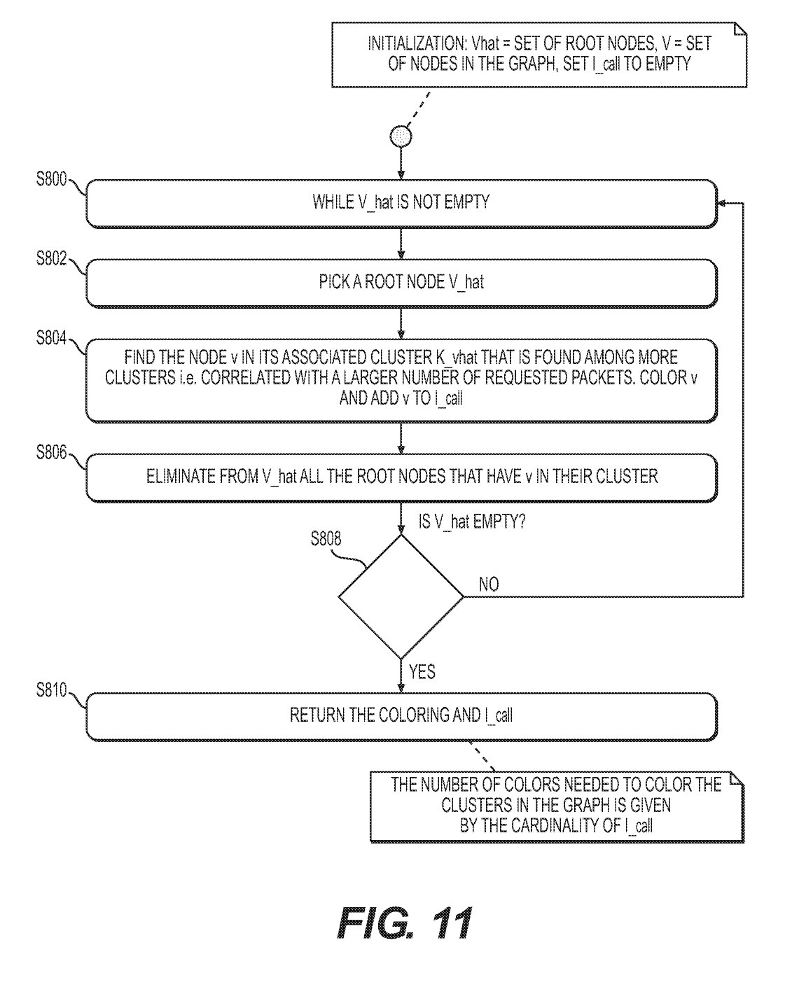

FIG. 10 is a flowchart illustrating the Greedy Cluster Coloring (GClC), in accordance with an example embodiment. In particular, the processor 158 of the network element 151 (FIG. 2) may be configured with a set of instructions for causing the processor 158 to perform these method steps, as described herein. The Greedy Cluster Coloring (GClC) takes as input the clustered conflict graph H_{C,Q}. It starts setting \tilde{V}=set of root nodes, \tilde{V}=virtual nodes, V=\hat{V}∪\tilde{V}=set of nodes in the graph; and I_call=empty. We would like to remark that the fact that node v has a label of size j denotes the fact that the chunk corresponding to vertex v is requested by Ru users and is cached in Cu such that Ru+Cu=j. Starting from the conflict graph built in step S604, the greedy Correlation-Aware Cluster Coloring, in step S700, chooses random a root node \hat{v}∈\hat{V} (denoted in the flowchart by v_hat) and it marks it as analyzed. Denote by Kᵥ cluster of root node v. Recall that the cluster node contain root node v and the associated virtual nodes corresponding to the packets in its δ-packet-ensemble G_{ρ(v)}. Then, in S702, the algorithm sorts the nodes in K_{\hat{v}} (denoted in the flowchart as K_vhat) in decreasing order of the their label size. In the following we denote by vₜ∈K_{\hat{v}} the t vertex in the ordered sequence obtained ordering the nodes in K_{\hat{v}}. The algorithm before step S704, sets: t=1; and Current_cardinality=0. In step S708, the algorithm takes vₜ∈K_{\hat{v}} and initialize I_vt to be equal to vₜ. In step S706, the algorithm includes in I_vt all the uncolored vertices in the graph having label equal to the one of vₜ that 1) do not belong to K_{\hat{v}}, 2) are not already in I_vt, 3) are not connected by a link in clustered conflict graph H_{C,Q}, and 4) that are not adjacent to vₜ in H_{C,Q}. Next in step S708, it computes the cardinality of I_vt denoted by |I_vt|. If |I_vt| is larger then Current_Cardinality, then the algorithm, step S712, sets v*_t equal to the v_t and set Current_Cardinality to |I_vt|. Next the algorithm verifies, in step S714, if Current_Cardinality larger or equal then the label size of vₜ. If NO, then in step S720, the algorithm increases t by one and goes back to step S704. If YES, then, in step S718, the algorithm 1) colors all the nodes in I_vt with an unused color, 2) include in I_call all the colored nodes in I_vt and 3) set V_1 empty. Next, 1) in step S724, it includes in V_1 any root node v_hat1 whose corresponding packet is delta correlated to a packet associated to a v1 in I_call and whose requesting user coincides with the users requesting v1, and 2) in step S726, it eliminates V_1 from V_hat. For each root node vj in V_1, the algorithm, in step in step S728, eliminates from V=\hat{V}∪\tilde{V} all the nodes contained in the corresponding cluster K_vj. At this point the algorithm checks if V_hat empty. If NO, the algorithm goes back to step S700. If YES, it returns the valid cluster coloring computed and I_cal. Recall that the number of colors needed to color the clusters in the graph is given by the cardinality of I_call in step S732. In step S734, it compares such cluster coloring with the one obtained by GClC₂, (see FIG. 11 for a flowchart illustrating GClC₂), selects and the best in term of total number needed to color the clusters in the graph, and in step S736 returns the selected coloring.

FIG. 11 is another flowchart illustrating GClC₂, one of the two components of the GClC, in accordance with an example embodiment. In particular, the processor 158 of the network element 151 (FIG. 2) may be configured with a set of instructions for causing the processor 158 to perform these method steps, as described herein. GClC₂ takes as input the clustered conflict graph H_{C,Q}. It starts setting \tilde{V}=set of root nodes, \tilde{V}=virtual nodes, V=\hat{V}∪\tilde{V}=set of nodes in the graph; and I_call=empty. While V_hat is not empty, the GClC, 1) picks a root node \hat{v}∈\hat{V} in step S802, 2) it finds the node v in its associated cluster K_{\hat{v}} that is found among more clusters i.e. correlated with a larger number of requested packets, 3) it colors v and 4) it adds v to I_call. Next, in step S806, GClC₂ eliminates from V_hat all the root nodes that have v in their cluster. If V_hat is not empty then GClC₂ goes back to step in step S800, if instead it is empty then GClC, returns the coloring and the associated I_call in step S810. Recall that the number of colors needed to color the clusters in the graph is given by the cardinality of I_call.

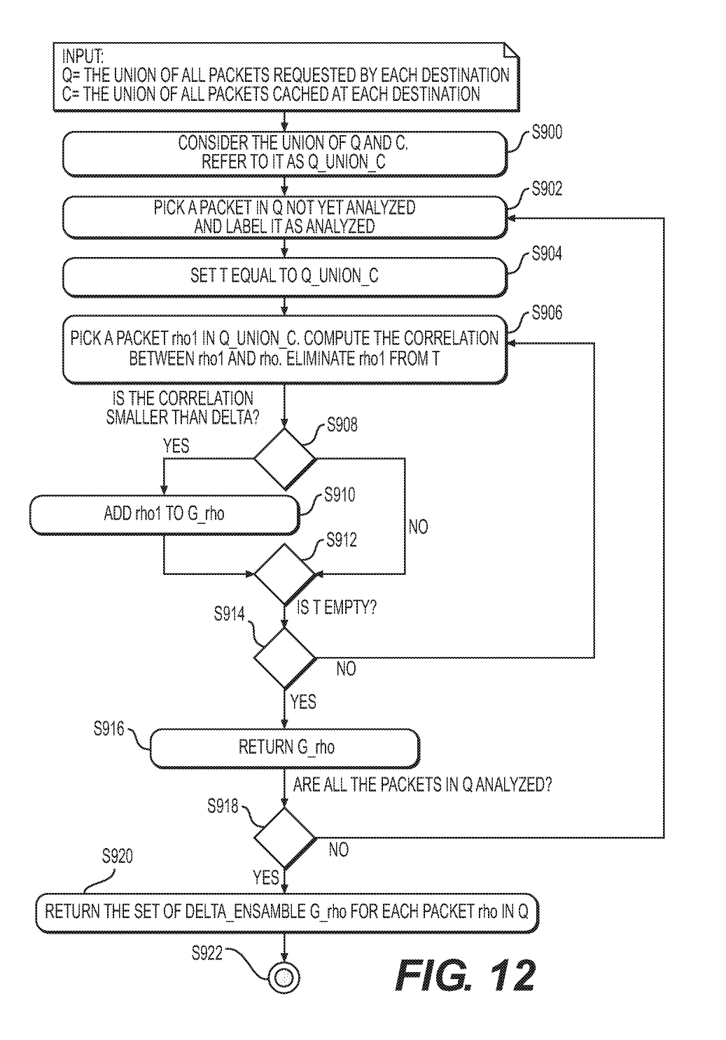

FIG. 12 is a flowchart of a method of Correlation-Aware Packet Clustering (see block 307) which is part of the optimal CA-CM encoder described in 302 and of the greedy CA-CM encoder described in 302a, in accordance with an example embodiment. In particular, the processor 158 of the network element 151 (FIG. 2) may be configured with a set of instructions for causing the processor 158 to perform these method steps, as described herein. The Correlation-Aware Packet Clustering takes as inputs:
The packet level user cache configuration, C={C₁, . . . , Cₙ} with C=the union of all packets cached at each destination where Cᵤ denotes the set of file-packet index pairs, (f,b), f∈[m], b∈[B], cached at receiver u.
The packet level user demand, Q=[Q₁, . . . , Qₙ], with [symbol] =the union of all packets requested by each destination i.e. where Qᵤ denotes the file-packet index pairs (f,b) associated with the packets of file W_{f}_{ᵤ} requested, but not cached, by receiver u.

In step S900 the Correlation-Aware Packet Clustering builds the union of Q=[Q₁, . . . , Qₙ] and C={C₁, . . . , Cₙ}. In the flowchart, we refer to it as Q_union_C. In step S902, the Correlation-Aware Packet Clustering picks a packet in Q=[Q₁, . . . , Qₙ] not yet analyzed and it labels it as analyzed. It sets T equal to Q_union in step S904 and in step S906 it, picks a packet rho1 in Q_union_C, it computes the correlation between rho1 and rho and it eliminates rho1 from T. In step S908, if the correlation is smaller then delta, the Correlation-Aware Packet Clustering adds rho1 to G_rho. At this point the Correlation-Aware Packet Clustering checks if T is empty. If NO the Correlation-Aware Packet Clustering goes back to step S906. If YES the Correlation-Aware Packet Clustering returns G_rho. Next the algorithm checks if all the packets in Q are analyzed. If this is the case then the Correlation-Aware Packet Clustering returns the set of delta_ensemble G_rho for each packet rho in Q, if not the Correlation-Aware Packet Clustering goes back to step S902.

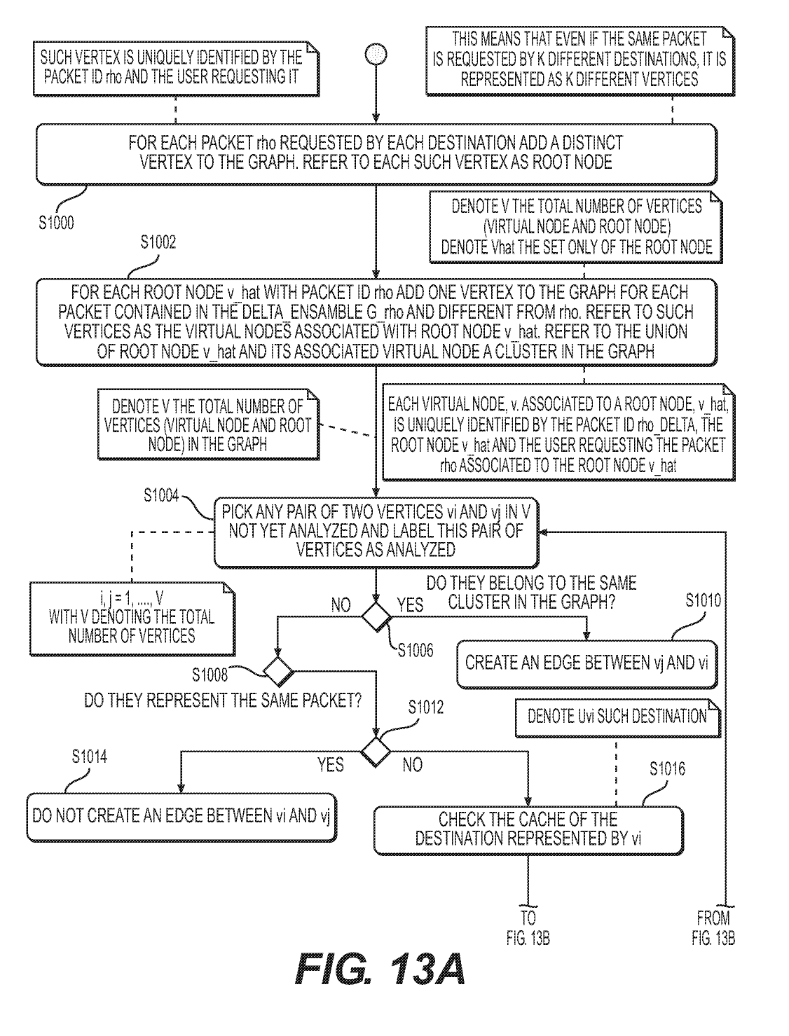

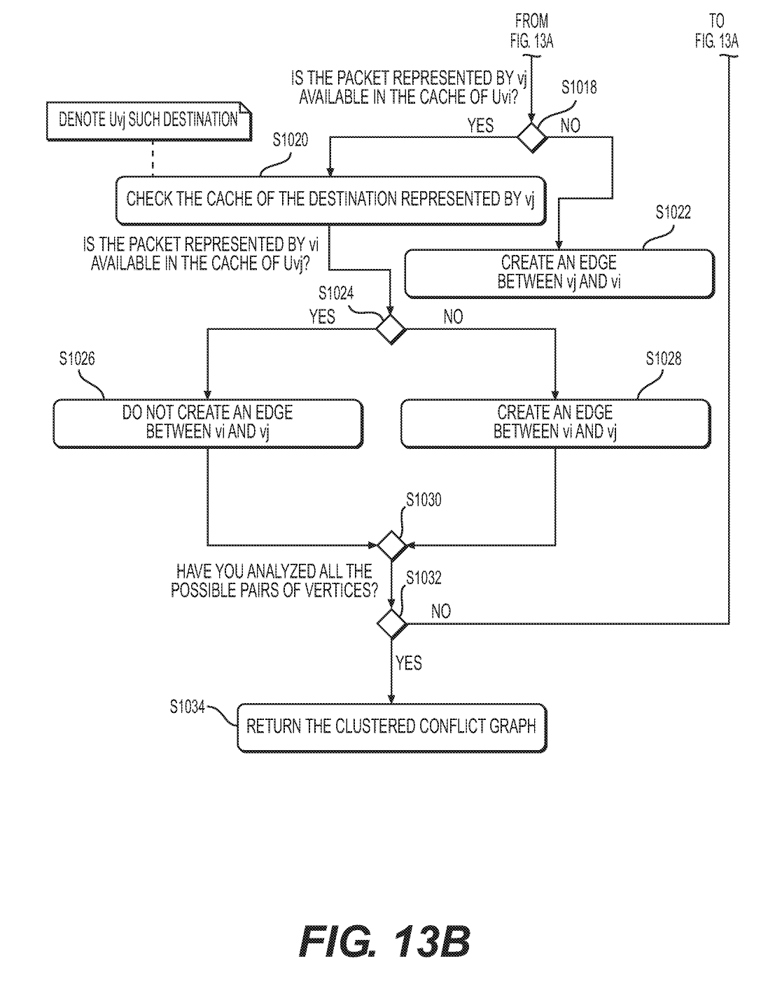

FIG. 13 is a flowchart illustrating a method of building a clustered conflict graph, in accordance with an example embodiment. In particular, the processor 158 of the network element 151 (FIG. 2) may be configured with a set of instructions for causing the processor 158 to perform these method steps, as described herein. The algorithm takes as inputs:
The packet level user cache configuration, C={C₁, . . . , Cₙ} with C=the union of all packets cached at each destination where Cᵤ denotes the set of file-packet index pairs, (f,b), f∈[m], b∈[B], cached at receiver u.
The packet level user demand, Q=[Q₁, . . . , Qₙ], with [symbol] =the union of all packets requested by each destination i.e. where Qᵤ denotes the file-packet index pairs (f,b) associated with the packets of file W_{f}_{ᵤ} requested, but not cached, by receiver u.

In step S1000, for each packet rho requested by each destination the algorithm adds a distinct vertex to the graph and it refers to each such vertex as root node. Next it denotes by \tilde{V} the set of the root nodes. In step S1002, for each root node \hat{v}∈\hat{V} with packet ID rho, the algorithm adds one vertex to the graph for each packet contained in the δ-packet-ensemble G_{ρ(v)} (denoted in the flowchart as G_rho) and different from rho. We refer to such vertices as the virtual nodes associated with root node \hat{v}∈\hat{V} (we refer to it as v_hat in the flowchart). We denote the set of virtual as \tilde{V}, and refer to the union of a root node and its associated virtual nodes as cluster in the clustered graph. Finally we denote by V=\hat{V}∪\tilde{V} set of all the nodes in the graph. Each root node \hat{v}∈\hat{V} is uniquely identified by the packet ID rho, and the user requesting the packet rho. Each virtual node, v, associated to a root node, \hat{v}∈\hat{V}, belongs to the associated cluster and it is uniquely identified by the packet ID rho delta, the root node v_hat and the user requesting the packet rho associated to the root node \hat{v}∈\hat{V}. Based on the above consideration, then for any given a node, vj, in the graph we always have a destination associated to that node: we denote by Uvj such the destination. In step S1004 the algorithm picks any pair of two vertices vi and vj in V not yet analyzed and label this pair of vertices as analyzed. In step S1006, the algorithm, first checks if they belong to the same cluster in the graph. If YES the algorithm creates an edge between them otherwise it checks if they represent the same packet in step S10010. If NO, in step S1008, it checks if the represent the same packet. If YES, in step S1014, the algorithm does not create any edge between vi and vj. If NO, in step S1016, it checks the cache of the destination represented by vi: Is the packet represented by vj available in the cache of Uvi? If NO then the algorithm creates an edge between vj and vi in step S1022. If YES the algorithm checks the cache of the destination represented by vj: Is the packet represented by vi available in the cache of Uvj? If NO the algorithm creates an edge between vj and vi in step S1028. If YES, in step S1026, the algorithm do no create an edge between vi and vj. At this point, in step S1030, the algorithm checks if all the possible pairs of vertices have been analyzed. IF NO the algorithm goes back to S1004. IF YES the algorithm returns the clustered conflict graph.

FIG. 14 illustrates a chromatic covering of a conflict graph, in accordance with an example embodiment.

### Performance of the CA-CACM Method:

In this section, an upper bound may be provided for a rate achieved with CA-CACM under the assumption that Mᵤ=M for all u∈U={1, . . . , n}.

Such characterization of the rate achieved with CA-CACM may be extended to a completely heterogenous setting where each user may have its own cache size, its own demand distribution, and request an arbitrary number of files.

For a given δ, the match matrix G may be defined as the matrix whose element G_{f′f} (f,f′)∈[m]² may be a largest value such that for each packet W_{f,b} of file f, there may be at least G_{f′f} packets of file f′ that may be δ-correlated with W_{f,b}, and may be distinct from the packets correlated with packet W_{f,b}, ∀b′∈[B].

Theorem 1:

Consider a broadcast caching network with n receivers, cache capacity M, demand distribution q, a caching distribution p, library size m, correlation parameter δ, and match matrix G. The achievable expected rate of CA-CACM, R(δ,p), may be upper bounded, as F→∞, with high probability shown as follows.

$$R ( δ , p ) \leq min \{ ψ ( δ , p ) + Δ R ( δ , p ) , \overline{m} \} , \\ where \\ ψ ( δ , p ) = {\sum }_{𝓁 = 1}^{n} ( \begin{matrix}n \\ 𝓁\end{matrix} ) {\sum }_{f = 1}^{m} {ρ}_{𝓁 , f} {λ}_{𝓁 , f} , \\ Δ R ( δ , p ) \leq n {\sum }_{f = 1}^{m} {q}_{f} ( 1 - {p}_{f} M ) ( 1 - {\prod }_{{f}^{′} = 1}^{m} {( 1 - {p}_{{f}^{′}} M )}^{{G}_{{f}^{′} f}} ) δ + {\sum }_{𝓁 = 1}^{n} 𝓁 ( \begin{matrix}n \\ 𝓁\end{matrix} ) {\sum }_{f = 1}^{m} {{ρ}_{𝓁 , f}^{*} ( 1 - {p}_{f} M )}^{( n - 𝓁 + 1 )} ( 1 - {( {p}_{f} M )}^{𝓁 - 1} ) {λ}_{𝓁 , f}^{*} , \\ \overline{m} = {\sum }_{f = 1}^{m} ( 1 - {( 1 - {q}_{f} )}^{n} ) , \\ with \\ {λ}_{𝓁 , f} = ( {\prod }_{{f}^{′} = 1}^{m} {( 1 - {p}_{{f}^{′}} M )}^{( n - 𝓁 + 1 ) {G}_{{f}^{′} f}} ) , \\ {ρ}_{𝓁 , f} = P \{ f = {arg max}_{d ∈ D} {λ}_{𝓁 , d} \} , \\ {λ}_{𝓁 , f}^{*} = ( {\prod }_{{f}^{′} = 1}^{m} {( 1 - {p}_{{f}^{′}} M )}^{( n - 𝓁 + 1 ) ( {( G - I )}_{{f}^{′} f} )} ) , \\ {ρ}_{𝓁 , f}^{*} = P \{ f = {arg max}_{d ∈ D} {( 1 - {p}_{d} M )}^{( n - 𝓁 + 1 )} ( 1 - {( {p}_{d} M )}^{𝓁 - 1} ) {λ}_{𝓁 , d}^{*} \} , \qquad Equation 2$$

D may denote a random set of [symbol] elements selected in an i.i.d. manner from [m], and I denoting the identity matrix.

The CA-RAP caching distribution may be computed as a minimizer of the corresponding rate upper bound, p*=argminₚ R(δ,p), resulting in the optimal CA-CACM rate R(δ,p*). The resulting distribution p* may not have an analytically tractable expression in general, but may be numerically optimized for the specific library realization. The rate upper bound may be derived for a given correlation parameter δ, whose value may also be optimized to minimize the achievable expected rate R(δ,p)

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A method of transmitting a plurality of data files in a network, comprising:
receiving, by at least one processor of a network node, requests from a plurality of destination devices for files of the plurality of data files, each of the requested files including at least one file-packet;
building, by the at least one processor, a conflict graph using popularity information and a joint probability distribution of the plurality of date files;
coloring, by the at least one processor, the conflict graph;
computing, by the at least one processor, a coded multicast using the colored conflict graph;
computing, by the at least one processor, a corresponding unicast refinement using the colored conflict graph and the joint probability distribution of the plurality of data files;
concatenating, by the at least one processor, the coded multicast and the corresponding unicast; and
transmitting, by the at least one processor, the requested files to respective destination devices of the plurality of destination devices.

2. The method of claim 1, wherein the building of the conflict graph includes,
calculating a first vertex for a first file-packet requested by a first destination device, of the plurality of destination devices, the first vertex including being one of a first virtual node and a first root node, the first virtual node being associated with a file packet requested by one of the destinations and stored in one of a destination cache of one of the plurality destination devices;
calculating a second vertex for a second file-packet requested by a second destination device, of the plurality of destination devices, the second vertex being associated with a second virtual node and a second root node; and
determining an edge between the first vertex and the second vertex in response to the first vertex and the second vertex belonging to a same cluster in the conflict graph and not representing a same file-packet.

3. The method of claim 2, further comprising:
caching content at each destination device based on the popularity information, wherein the calculation (calculation is not correct is identification the right word) of the first vertex is accomplished using the joint probability distribution of the plurality of data files and the content cached at the destination devices, wherein the determining the edge between the first vertex and the second vertex is further accomplished in response to the caching of the content at each destination device in response to the first vertex and the second vertex not representing a same file-packet.

4. The method of claim 3, wherein the building of the conflict graph further includes,
checking a first cache of the first destination device to determine whether the second file-packet is available in the first cache, wherein the determining of the edge between the first and second vertex is performed in response to the second file-packet being available in the first cache; (please note that the expression the first cache of the first destination and second cache of the second destination can be misleading i understand what do you mean but writing like this looks like that a destination has multiple caches)
checking a second cache of the second destination device to determine whether the first file-packet is available in the second cache, wherein the determining of the edge between the first vertex and the second vertex is performed in response to the first file-packet being available in the second cache; and
repeating the calculating, determining, caching and checking steps with pairs of additional vertices for additional requested file-packets for each of the plurality of destination devices.

5. A device, comprising:
a non-transitory computer-readable medium with a program including instructions; and
at least one processor configured to perform the instructions such that the at least one processor is configured to,
receive requests from a plurality of destination devices for files of the plurality of data files, each of the requested files including at least one file-packet,
build a conflict graph using popularity information and a joint probability distribution of the plurality of date files,
color the conflict graph,
compute a coded multicast using the colored conflict graph,
compute a corresponding unicast refinement using the colored conflict graph and the joint probability distribution of the plurality of data files,
concatenate the coded multicast and the corresponding unicast, and
transmit the requested files to respective destination devices of the plurality of destination devices.

6. The device of claim 5, wherein the at least one processor is configured to build the conflict graph by,
calculating a first vertex for a first file-packet requested by a first destination device, of the plurality of destination devices, the first vertex including being one of a first virtual node and a first root node, the first virtual node being associated with a file packet requested by one of the destinations and stored in one of a destination cache of one of the plurality destination devices,
calculating a second vertex for a second file-packet requested by a second destination device, of the plurality of destination devices, the second vertex being associated with a second virtual node and a second root node, and
determining an edge between the first vertex and the second vertex in response to the first vertex and the second vertex belonging to a same cluster in the conflict graph and not representing a same file-packet.

7. The device of claim 6, wherein the at least one processor is further configured to,
cache content at each destination device based on the popularity information, wherein the calculation (calculation is not correct is identification the right word) of the first vertex is accomplished using the joint probability distribution of the plurality of data files and the content cached at the destination devices, wherein the determining the edge between the first vertex and the second vertex is further accomplished in response to the caching of the content at each destination device in response to the first vertex and the second vertex not representing a same file-packet.

8. The device of claim 7, wherein the at least one processor is configured to build the conflict graph by,
checking a first cache of the first destination device to determine whether the second file-packet is available in the first cache, wherein the determining of the edge between the first and second vertex is performed in response to the second file-packet being available in the first cache;
checking a second cache of the second destination device to determine whether the first file-packet is available in the second cache, wherein the determining of the edge between the first vertex and the second vertex is performed in response to the first file-packet being available in the second cache; and
(please note that the expression the first cache of the first destination and second cache of the second destination can be misleading i understand what do you mean but writing like this looks like that a destination has multiple caches)
repeating the calculating, determining, caching and checking steps with pairs of additional vertices for additional requested file-packets for each of the plurality of destination devices.

9. A network node, comprising:
a memory with non-transitory computer-readable instructions; and
at least one processor configured to execute the computer-readable instructions such that the at least one processor is configured to,
receive requests from a plurality of destination devices for files of the plurality of data files, each of the requested files including at least one file-packet,
build a conflict graph using popularity information and a joint probability distribution of the plurality of date files,
color the conflict graph,
compute a coded multicast using the colored conflict graph,
compute a corresponding unicast refinement using the colored conflict graph and the joint probability distribution of the plurality of data files,
concatenate the coded multicast and the corresponding unicast, and
transmit the requested files to respective destination devices of the plurality of destination devices.

10. The network node of claim 9, wherein the at least one processor is configured to build the conflict graph by,
calculating a first vertex for a first file-packet requested by a first destination device, of the plurality of destination devices, the first vertex being one of a first virtual node and a first root node, the first virtual node being associated with a file packet requested by one of the destinations and stored in one of a destination cache of one of the plurality destination devices,
calculating a second vertex for a second file-packet requested by a second destination device, of the plurality of destination devices, the second vertex being associated with a second virtual node and a second root node, and
determining an edge between the first vertex and the second vertex in response to the first vertex and the second vertex belonging to a same cluster in the conflict graph and not representing a same file-packet.
